(19) United States
(12) Patent Application Publication
(10) Pub. No.: US 2009/0112648 A1
(43) Pub. Date: Apr. 30, 2009

(54) ONLINE SALES AND MARKETING INTEGRATION

(75) Inventors: David J. Lee, Redmond, WA (US); Samarth S. Pai, Bellevue, WA (US); Brian G. Jeans, Snoqualmie, WA (US); William H. Homes, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/928,058

(22) Filed: Oct. 30, 2007

(51) Int. Cl. G06Q 10/00; G06Q 30/00

(52) U.S. Cl. 705/7

(57) ABSTRACT

Various online sales and marketing activities and data are integrated into a single cohesive system capable of generating and modifying marketing strategies based on collected data and coordinating sales and marketing efforts using online tools. Different management modules or applications for online sales and advertising activities in a networked environment provide input to an analysis module, which provides feedback to a recommendation or campaigning module for coordinating and optimizing online marketing activities. Online activities are then executed based on the recommendations resulting in an organized integration of sales and marketing tools. The system may be implemented in a solution marketplace platform as an iterative loop that also provides access to Independent Software Vendors through standardized interfaces.

### BACKGROUND

Online services have become common tools for sales and marketing for businesses and other organizations. Some businesses also utilize automated information systems to help automate sales and sales force management functions. A sales force automation system typically includes a contact management system, which tracks contacts established with existing and new customers; a sales lead system, which lists potential customers; an order tracking system; a forecasting system; and other components such as product knowledge.

On the marketing side, marketing personnel typically receive information from the sales side and utilize different marketing tools to generate strategies for marketing based on information collected through sales operations and other avenues. Small businesses, in particular, use a wide variety of sales and marketing services that are commonly not well integrated. For example, they might have a web site, purchase keywords from internet search engines, keep a list of customers, send email or direct mail to the customers, track the success of various efforts, etc. But each of these may be isolated tools requiring human intervention, transfer (and often translation) of data between different systems, and human decision making at each step of the process. This may result in missed opportunities and extra work for small businesses.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to integrating various online sales and marketing activities and data into a single cohesive system that is capable of generating and/or modifying marketing strategies based on collected data and coordinating sales and marketing efforts using online tools. According to some embodiments, various management modules or applications for online sales and advertising activities provide input to an analysis module (application), which provides feedback to a recommendation module for suggesting new online marketing activities or a campaigning module for coordinating current online marketing activities based on community-sourced best practices.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 is a conceptual diagram illustrating an architecture of an integrated sales and marketing system;

FIG. 2 illustrates major components of an example integrated sales and marketing system for automated coordination of sales and marketing activities some of which may be online;

FIG. 3 illustrates example components and interactions between those components in an integrated sales and marketing system for online sales and marketing activities;

FIG. 4 is a networked environment where an automated sales and marketing system according to embodiments may be implemented;

FIG. 5 is a block diagram of an example computing operating environment, where embodiments may be implemented; and

FIG. 7 illustrates a logic flow diagram of an example process of integrating automated online sales and marketing activities according to embodiments.

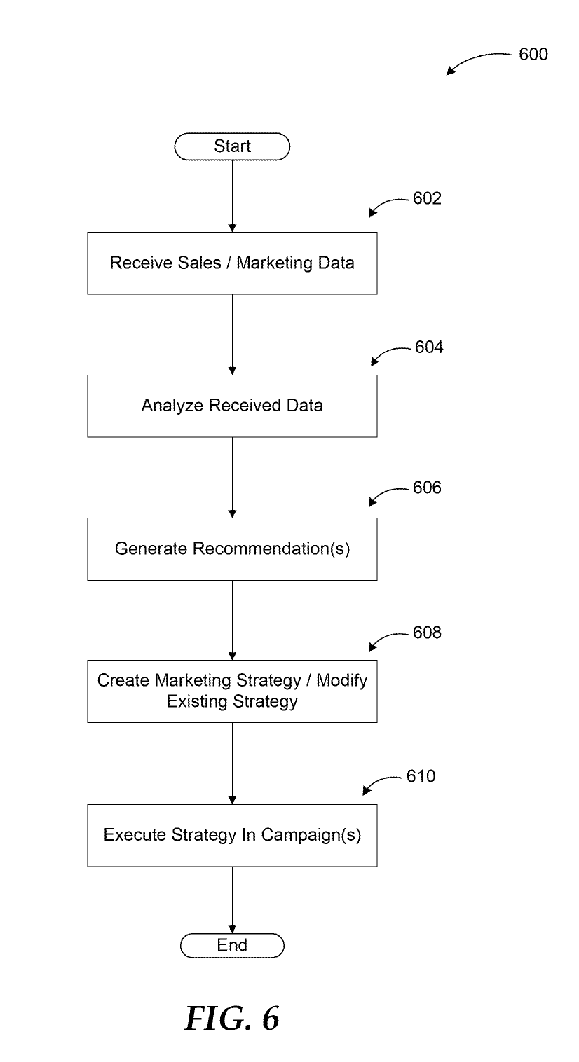

### DETAILED DESCRIPTION

As briefly described above, various online sales and marketing activities and data may be integrated into a single cohesive system that can generate and/or modify marketing strategies based on collected data and coordinate sales and marketing efforts using online tools. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process.

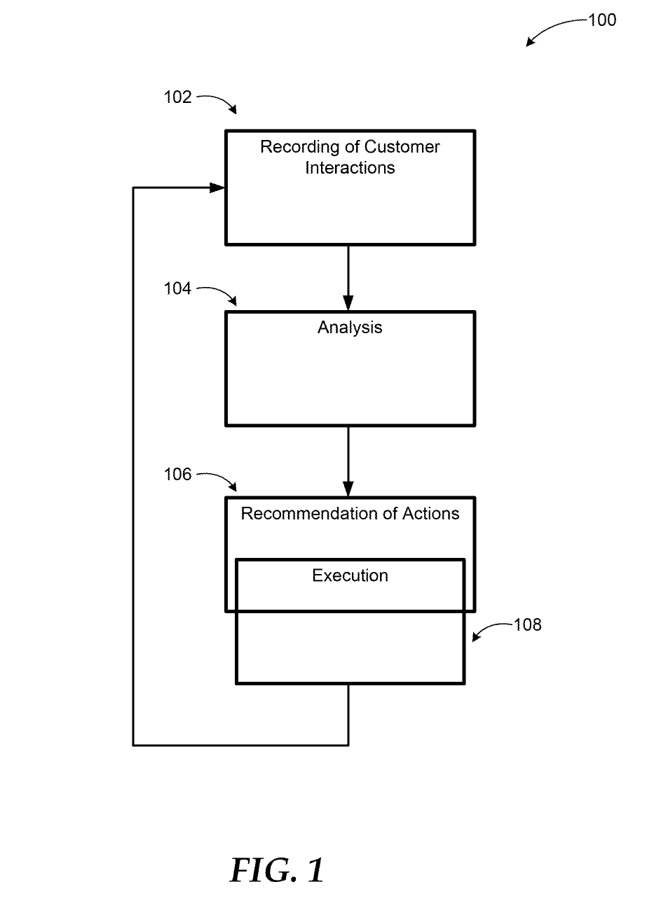

Referring to FIG. 1, a conceptual diagram of the architecture of an example integrated sales and marketing system is illustrated. Such a system may be implemented as a local application with communication capabilities through a number of networks, a distributed application over a number of computing devices, or as a hosted service integrating a suite of applications with subscribers taking advantage of various features.

Marketing activities may be implemented as campaigns based on strategies developed and modified in response to feedback from sales and advertising activities. For example, a small business may want to create an email advertising campaign for consumable products to customers that have a pattern of purchasing the items in the past. With just a few clicks in a system user interface, a system according to embodiments may automatically identify appropriate products, customers, and email content. Then, the system may track the success of the campaign and report on the success (sales that followed directly from the campaign and the cost of sending the emails) such that the sales and campaigning activities can be further optimized.

As a result of integrating online sales and marketing activities, sales force may save time and effort by eliminating use of paper-based sales orders, reports, activity reports, product inventory data, sales prospect lists, and sales support information. Such information is also one aspect of feedback for developing marketing strategies. Thus, instead of manual compilation and interpretation of data from these sources, the system may automatically analyze the collected sales data, generate necessary feedback (e.g. Key Performance Indicators “KPIs”), and provide them to a recommendation block comprising one or more modules for generating or optimizing marketing campaigns. By automating the integrated execution of sales and marketing activities, a sales person's ratio of selling time to non-selling time may be increased significantly. Non-selling time includes activities like report writing, travel time, internal meetings, training, and seminars.

Furthermore, managers would not only minimize manual efforts in preparing activity reports, respond to information requests, monitoring orders booked, or analyzing sales information and advertising campaign success, but also receive automated marketing research data such as demographic, psychographic, behavioral, product acceptance, product problems, detecting trends, and the like.

More importantly, parameters in determining marketing strategies and organizing campaigns may be automatically defined and transferred between the components of the integrated system. Such parameters may include identifying profitable customers, tracking productivity of sales approaches and advertising based on revenue per sales person, revenue per territory, margin by, margin by customer segment, margin by customer, number of calls per day, time spent per contact, revenue per call, cost per call, entertainment cost per call, ratio of orders to calls, revenue as a percentage of sales quota, number of new customers per period, number of lost customers per period, cost of customer acquisition as a percentage of expected lifetime value of customer, percentage of goods returned, number of customer complaints, and the like.

From a marketing perspective, online tools for designing and executing marketing strategies may be enabled to identify segments within a target market and valuable customers, to develop profiles (demographic, psychographic, and behavioral) of core customers, understand strengths and weaknesses of past and current campaigns, to modify marketing strategies for the products using the marketing mix variables of price, product, distribution, and promotion, and coordinating the sales function with other parts of the promotional mix (such as advertising, sales promotion, public relations, and publicity). This way, a sustainable competitive advantage may be created. According to some embodiments, an integrated sales and marketing activities system may be fully automated. Such a system may examine analysis results (e.g. KPIs) and take actions on behalf of a business client to start marketing campaigns of various kinds (e.g. an email marketing campaign).

A system according to embodiments may include four core functionalities in its architecture as shown in diagram 100. First functionality is recording of customer interactions 102. This includes any customer contacts, such as inquiries, feedback, sales follow-ups, surveys, and the like. Recorded information from customer interactions may be analyzed in the second core functionality, analysis 104. The analysis may be performed by one or more modules of the system, by external applications, and the like. The analysis may have a wide ranging spectrum from simple compilation of data to user-defined key performance indicator (or “KPI”) based metric analysis of various factors. The results of the analysis may be provided to recommendation of actions functionality 106, which generates recommended marketing strategies such as well defined campaigns. As discussed in the example above, results of an email marketing campaign may be analyzed based on customer responses and the campaign fine-tuned (e.g. modification of target audience, email contents, etc.) for enhanced success of the campaign. Recommended actions may be executed by the same modules (or applications) generating the recommendations or by other modules (or applications).

More specifically, a system according to embodiments records customer interactions of a business in a consistent and traceable manner, recommends action to the business to improve sales by analyzing the business's public website content, product offerings, historical sales and marketing data and making inferences based on success or failure of similar businesses, and provides documented interfaces for third party providers to incorporate their services to the integrated sales and marketing platform.

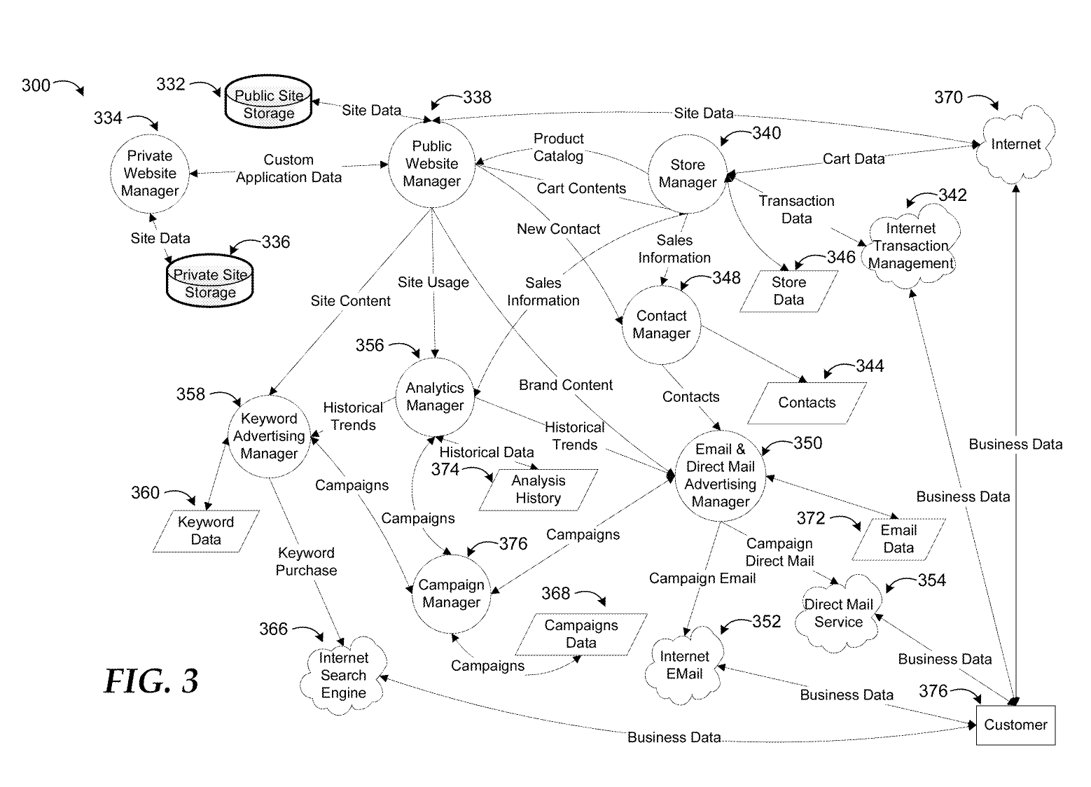

Embodiments described below refer to applications and/or modules such as those discussed above, but they are not limited to specific applications. Any application or hosted service that performs automated sales and marketing tasks in a networked environment may be integrated using the principles described herein. More concrete examples of such an integration are discussed in conjunction with FIG. 3. While the Internet is frequently mentioned for example systems, systems according to embodiments may also utilize private networks, and other communication means.

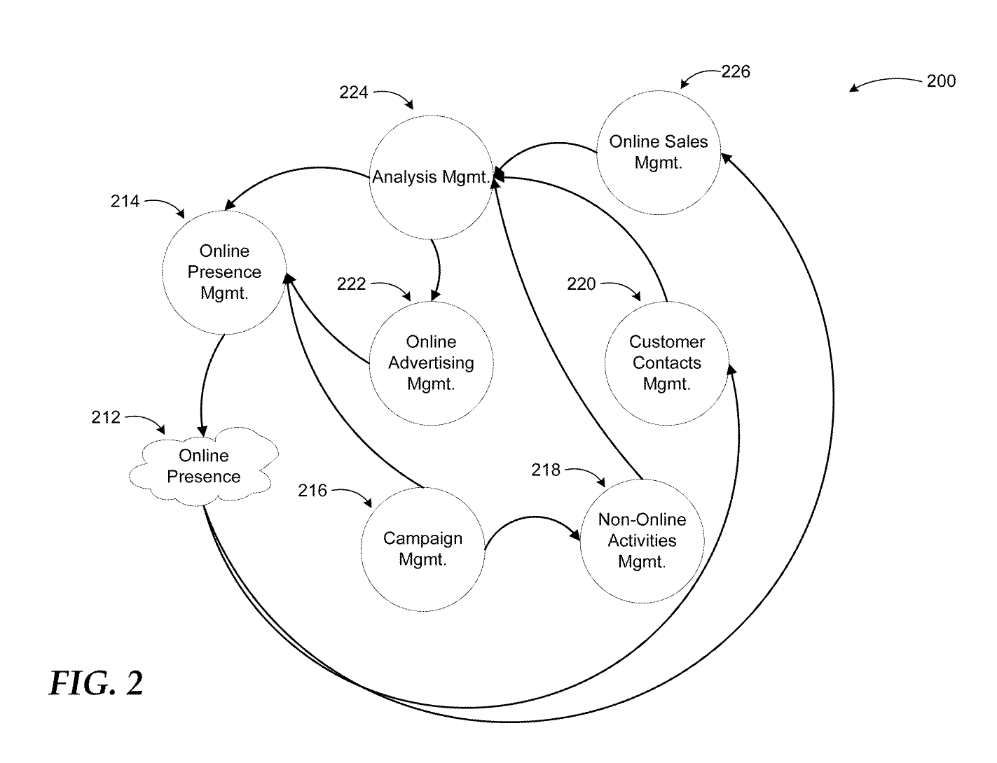

FIG. 2 illustrates major components of an example integrated sales and marketing system for automated coordination of sales and marketing activities some of which may be online. While major components corresponding to core functionalities of an integrated system are shown in diagram 200, these functionalities may of course be executed by additional or fewer components.

At the core of an integrated online sales and marketing system is a business's online presence 212, which typically includes a public website with sales information, customer support information, advertising information, and the like. The public website may be complemented by one or more private website supporting the public website for enhanced online presence. Online presence 212 is managed by the online presence management component 214 which coordinates compilation and formatting of data associated with the public website as well as facilitates network communications between other components and the websites.

Information for generating recommendations is collected by and received from online sales management component 226, customer contacts management component 220, and non-online activities management component 218. The non-online activities may include data collected through customer returns, regular mail interaction with customers, or phone interaction with customers. The collected data is analyzed by analysis management component 224. As discussed previously, the analysis may vary in complexity and may be performed by a number of internal and external components such as a scorecard application, a data mining application, and the like. The analysis management component 224 may provide analysis results to online advertising management component 222. This component may generate recommendations based on the analysis results for existing or new campaigns and provide them to campaign management component 216. Campaign management component may execute tasks creating or modifying coordinated campaigns such as emails campaigns, keyword purchases, website advertisement, and the like. Campaign management component 216 may then provide feedback to online presence management component 214 for appropriate activities on public and private websites, as well as to non-online activities management component 218 for any related actions.

FIG. 3 illustrates example components and interactions between those components in an integrated sales and marketing system for online sales and marketing activities. Diagram 300 includes example components and interactions for a small business integrated sales and marketing system, which may be implemented with additional or fewer components that interact in additional ways than those described in the figure. A business utilizing an integrated sales and marketing system may be one that provides goods, services, or both.

A public web site is typically created by the business to help promote the business to their customers. It may contain information about the business, offer goods and services for sale, and provide customer support services. Managed by public website manager 338, which may store data in public site storage 332, and presented to customers over the Internet 370, the public website can be a valuable tool for collection of potential leads and expose additional applications built by third party providers for exchange of information between businesses and their customers. Customer 376 interacts with the business through the public website on the Internet 370. Public website manager 338 may also send data associated with customer interactions to the analytics manager 356.

Store manager 340 enables the business to define the goods and services it offers through its website(s). It also provides shopping cart and online service-delivery scheduling functionality as well as interaction with transaction processing services (342) by third parties such as credit card billing. Store manager 340 may provide sales interaction data to analytics manager 356 and customer information to contact manager 348 generating store data 346.

Contact manager 348 enables the business to have a list of its prospects and customers. Customers can add themselves via a user interface on the public web site or the information may be collected through advertising contacts, sales, post-sales follow-ups, and the like. Sales history and email interactions with customers may also be managed and stored by contact manager 348 in the form of contacts data 344. New advertising campaigns may be created based on selective views of customers employing criteria such as duration as a customer, purchase history, etc.

Email and direct mail advertising manager 350 may coordinate marketing campaigns around each of these media (352, 354). This manager may consume images and text that incorporate the business brand information created on the public web site for consistent messaging to customers. All media sent to customers may contain campaign tracking information to be later consumed by the analytics manager 356.

The keyword advertising manager 358 enables the business to purchase keywords on internet search engines 366. It may generate suggestions (keyword data 360) based on the content of the public web site as well as historical success of various keywords in driving traffic to the public web site and sales of products.

Analytics manager 356 is the central hub of information in the system. Analytics manager 356 aggregates various activities and may create analytic reports such as KPI reports for business owners around the effectiveness of other components such as the public web site, campaigns, etc. The data (e.g. analysis history data 374) may also help inform suggested actions for improved sales as presented by components such as the keyword advertising manager 358.

Campaign manager 376 coordinates sales and marketing campaigns across all media such as keywords, email, and direct mail. Campaign manager 376 interacts with other advertising managers based on feedback received from analytics manager 356 and generates campaign data 368. The analytics manager 356 and the user interfaces for each media may be made aware of the campaigns through campaign data 368.

Private web site manager 334 may provide an authenticated web site that the business employees and their designees can use. Private web site manager 334 may serve as a platform for software developers on which applications can be built that are similar to the other applications in the system with respect to sharing data. Applications built on this platform can exchange information with other applications further enriching the overall business experience. For example, an application may be built by a third party (e.g. Independent Software Vendor “ISV”) and sold to the business providing a scheduling service, and the like. Consumers may navigate to the public web site, view a calendar of open times, book a time, and have that time recorded in private site storage 336, resulting in the service being provide according to the calendar as viewed on the private web site.

Embodiments are not limited to the example manager components and interaction architecture provided in this figure. An integrated system may be implemented with a number of additional manager components and functionalities depending on the needs of a business. Furthermore, a hosted service providing the integrated sales and marketing services to multiple businesses may implement these components in a scalable and customizable architecture that includes document interfaces such that user can further integrate third party modules that wish to use as part of their integrated system.

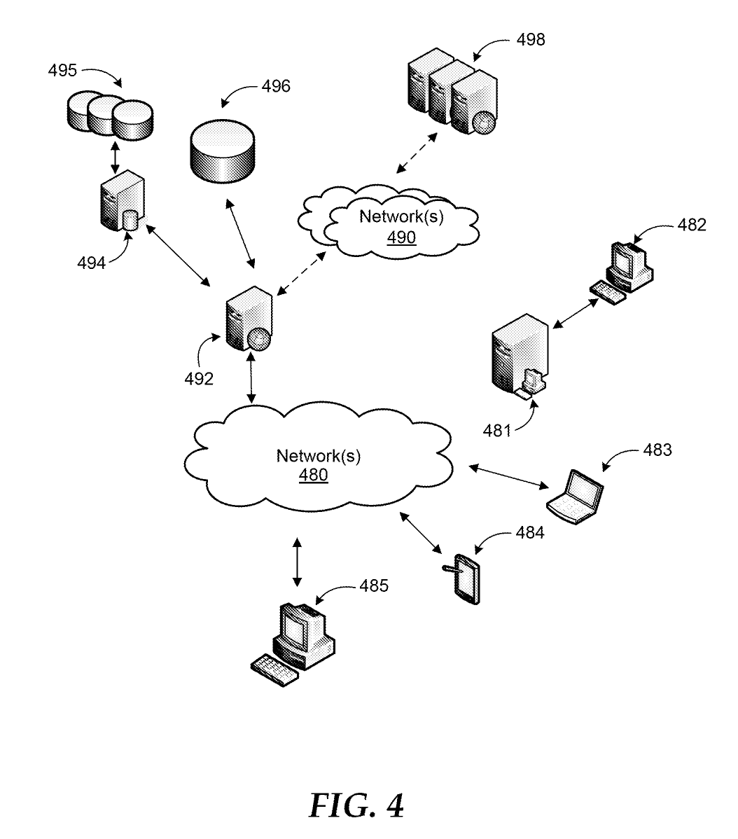

FIG. 4 is an example networked environment, where embodiments may be implemented. An integrated sales and marketing activities system may be implemented employing local or distributed applications running on one or more computing devices configured in a distributed manner over a number of physical and virtual clients and servers. It may also be implemented in un-clustered systems or clustered systems employing a number of nodes communicating over one or more networks (e.g. network(s) 480).

Such a system may comprise any topology of servers, clients, Internet service providers, and communication media. Also, the system may have a static or dynamic topology, where the roles of servers and clients within the system's hierarchy and their interrelations may be defined statically by an administrator or dynamically based on availability of devices, load balancing, and the like. The term “client” may refer to a client application or a client device. While a networked system implementing integrated sales and marketing activities may involve many more components, relevant ones are discussed in conjunction with this figure.

As mentioned above, a hosted service or an application providing integrated sales and marketing services may be executed by server 492 and accessed for providing data, receiving reports, and for other interactions by users (both businesses and their customers) through client devices 483-485 or through client device 482 managed by server 481. Server 492 may interact with data stores for storing various data associated with the sales and marketing services such as data store 496 or data stores 495 managed by database server 494. Additional servers (and/or clients) may be involved in providing the integrated sales and marketing services system such as servers 498, which communicate with server 492 through network(s) 490. Network(s) 490 may be a public network such as the Internet or private networks.

Network(s) 480 (and 490) may include a secure network such as an enterprise network, an unsecure network such as a wireless open network, or the Internet. Network(s) 480 provide communication between the nodes described herein. By way of example, and not limitation, network(s) 480 and 490 may include wired media such as a wired network or direct-wired connection, and wireless media such as acoustic, RF, infrared and other wireless media.

Many other configurations of computing devices, applications, data sources, data distribution systems may be employed to implement an integrated sales and marketing activities system. Furthermore, the networked environments discussed in FIG. 4 are for illustration purposes only. Embodiments are not limited to the example applications, modules, or processes.

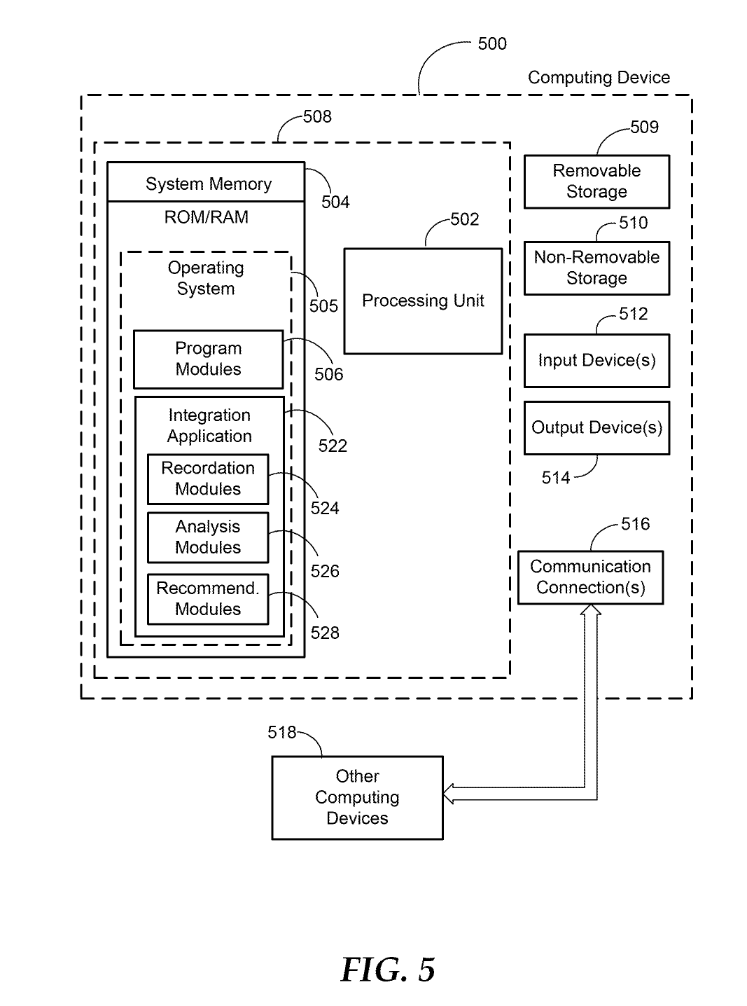

FIG. 5 and the associated discussion are intended to provide a brief, general description of a suitable computing environment in which embodiments may be implemented. With reference to FIG. 5, a block diagram of an example computing operating environment is illustrated, such as computing device 500. In a basic configuration, the computing device 500 may be a server managing the integrated service. Computing device 500 may typically include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of a networked personal computer, such as the WINDOWS® operating systems from MICROSOFT CORPORATION of Redmond, Wash. The system memory 504 may also include one or more software applications such as program modules 506, Integration application 522, recordation modules 524, analysis modules 526, and recommendation modules 528.

Integration application 522 may be any application or hosted service providing integrated sales and marketing services to business clients. Recordation modules 522 may include any manager modules that receive information associated with the sales and marketing activities and store them for analysis and further use by the system. Analysis modules 526 may include one or more modules (or applications) that perform analysis on collected information for improving sales and marketing success of the business. Recommendation modules 528 receive the analysis reports and generate recommendations for creating new marketing strategies or modifying existing ones to implement campaigns (e.g. advertising campaigns). This basic configuration is illustrated in FIG. 5 by those components within dashed line 508. The functionality of integration application 522 does not have to be assigned to the distinct modules as described here. The above disclosed functionality may be performed by more or fewer modules or all by the same application (or service).

The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer storage media may include volatile and nonvolatile, removable and non-removable media implemented in any method or technology for storage of information, such as computer readable instructions, data structures, program modules, or other data. System memory 504, removable storage 509, and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of device 500. Computing device 500 may also have input device(s) 512 such as keyboard, mouse, pen, voice input device, touch input device, etc. Output device(s) 514 such as a display, speakers, printer, etc. may also be included. These devices are well known in the art and need not be discussed at length here.

The computing device 500 may also contain communication connections 516 that allow the device to communicate with other computing devices 518, such as over a wireless network in a distributed computing environment, for example, an intranet or the Internet. Other computing devices 518 may include web servers, database servers, file servers, provider servers, and the like. Communication connection 516 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The claimed subject matter also includes methods of operation. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

FIG. 6 illustrates a logic flow diagram of an example process 600 for integrating automated online sales and marketing activities according to embodiments. Process 600 may be implemented in any networked environment. Process 600 may be implemented as part of a solutions marketplace platform, where businesses may take advantage of semi or fully automated integration of sales and marketing activities. In such as platform, demand capture in the early portion of the process lead to demand fulfillment using tools known to drive value, which in turn results in further demand generation through integration of sales and marketing activities. Thus, the process is not an closed process. Neither is it a one-time process. The more likely implementation is a continuous loop of the described operations in an iterative manner. Furthermore, a solution marketplace platform as described above may be an open platform, where Independent Software Vendors (ISVs) can participate through standardized interfaces.

Process 600 begins with operation 602, where data collected during sales (and marketing) activities such as customer contact information, sales information, and the like is received through various components of the system from their respective interactions with customers, and other information sources. As discussed above, the system may be an open system, where syndicated data from third party providers may also be used in the subsequent analysis operation. Processing continues to operation 604 from operation 602.

At operation 604, the received data is analyzed for different metrics. The analysis may include quantitative and qualitative evaluation of sales, customer evaluations, evaluations of advertising campaign results, and others. The analysis may be performed internally and externally with the results being provided to a recommendation component of the system. Processing moves to operation 606 from operation 604.

At operation 606, recommendations for new and existing marketing strategies are made based on the analysis results. Marketing strategies may involve targeted advertising campaigns, which may be created or modified based on the results enabling the campaigns to be more targeted and successful. Furthermore, campaign successes may be measured and historic information stored. In a hosted service providing the integration to a plurality of businesses, the recommendations may be generated also based on historic success factors of similar businesses. Processing moves from operation 606 to operation 608.

At operation 608, new marketing strategies are created or existing ones modified as discussed above. Processing advances from operation 608 to operation 610, where campaigns based on the created/modified marketing strategies are executed. Feedback mechanisms for collecting data associated with the executed campaigns may also be utilized as part of the execution of the campaigns. After operation 610, processing moves to a calling process for further actions.

The operations included in process 600 are for illustration purposes. Integrating automated online sales and marketing activities may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for integrating online sales and marketing activities, the method comprising:
receiving sales interaction data that is recorded in a consistent and traceable manner;
receiving marketing data;
analyzing the received sales interaction data and the marketing data to determine at least one recommendation associated with at least one of an existing marketing strategy and a new marketing strategy;
generating the at least one recommendation for at least one of modifying the existing marketing strategy and creating the new marketing strategy;
generating a campaign based on the at least one recommendation; and
executing the campaign utilizing the sales interaction data, the marketing data, and at least one of an existing marketing strategy and a new marketing strategy.

2. The method of claim 1, wherein the sales interaction data includes at least one from a set of: customer contact information, historic sales information, customer inquiries, post-sales follow-up information, customer survey information, community results, and syndicated data based on other marketing campaign results.

3. The method of claim 1, wherein the marketing data includes at least one from a set of: keyword advertising information, target customer group information, brand usage information, and historic trend information.

4. The method of claim 1, further comprising:
performing the analysis of the received data by one of an internal component of an integrated online sales and marketing service and an external application associated with the service.

5. The method of claim 4, further comprising:
enabling a user of the integrated online sales and marketing service to incorporate a third party provider component for performing one of data collection, analysis, recommendation generation, and campaign execution services into the integrated online sales and marketing service.

6. The method of claim 1, wherein the campaign includes at least one from a set of: a direct mailing campaign, an email campaign, a keyword advertising campaign, a bannered campaign, an offline print campaign, and a cold calling campaign.

7. The method of claim 1, wherein the sales interaction data is collected through a public website that includes an online store whose content and presentation is modified in response to the generated campaign.

8. A system for integrating online sales and marketing activities, the system comprising:
at least one server configured to facilitate a hosted service for integrated online sales and marketing, wherein the hosted service includes:
an online sale management component for coordinating online sales for clients of the hosted service and collecting sales interaction data;
a customer contact management component for receiving and tracking up-to-date contact information of existing and potential customers of the clients of the hosted service;
an analysis management component for facilitating analysis of data collected by the online sales management and customer contact management components;
a campaign management component for generating marketing campaigns based on analysis results from the analysis management component and business directives of the clients of the hosted service;
an advertising component for facilitating at least one from a set of: online advertising, email advertising, direct mail advertising, and keyword advertising as part of the generated marketing campaigns; and
an online presence management component for managing public and private websites of the clients of the hosted service, updating the public and private websites based on current marketing campaigns, submitting online advertising and keyword purchases to other web service providers on behalf of the clients of the hosted service, and providing feedback to the analysis management component; and
at least one data store for storing data associated with the hosted service.

9. The system of claim 8, wherein the hosted service further includes:
a private website management component for facilitating non-public operations of the clients of the hosted service in a secure network environment, wherein at least one of the operations and data of each client's private website is updated based on operations and data of the corresponding client's public website.

10. The system of claim 8, wherein the hosted service further includes:
a non-online activities management component for coordinating sales and marketing activities not executed through online tools with those executed through online tools managed by the components of the hosted service.

11. The system of claim 8, wherein the analysis management component is further arranged to analyze a product offering through content of the public website of a client of the hosted service, product offerings of the client of the hosted service, historic sales and advertising data of the client of the hosted service, and make an inference based on a success of a different client of the hosted service with correlating business attributes.

12. The system of claim 8, wherein the hosted service further includes:
an online store management component for facilitating sales through the public website of the client of the hosted service, collecting sales and customer contact information for each sale, and providing sales information to the analysis management component and customer contact information to the customer contact management component, wherein the online store management component is further configured to interact with at least one third party service for a sales transaction.

13. The system of claim 8, wherein the advertising management component includes at least one module for managing online keyword purchases, one module for managing email advertising, one module for managing direct mail advertising, one module for managing advertising on the public website, and one module for offline advertising attracting potential customers to at least one of a website and a phone number.

14. The system of claim 13, wherein the campaign management component is further arranged to direct execution of advertising campaigns by the modules of the advertising management component.

15. The system of claim 8, wherein the hosted service is scalable and customizable with at least one of default modules and third party modules based on a need of each client of the hosted service.

16. A computer-readable storage medium with instructions encoded thereon for integrating online sales and marketing activities, the instructions comprising:
providing a hosted service for sales and marketing activities to a plurality of business clients with online presence, wherein the hosted service includes:
a website manager module for managing public and private websites of the business clients, updating the public and private website contents based on current marketing campaigns, submitting online advertising and keyword purchases to other web service providers on behalf of the business clients, and collecting data from customer contacts through the public websites;
an online store manager module for managing online sales of the business clients and collecting transaction, customer contact, and post-sales follow-up data;
a customer contact manager module for receiving and tracking up-to-date contact information of existing and potential customers of the business clients;
an analytics manager module for facilitating business metric analysis of data collected by the website manager, online store manager, and customer contact manager modules, wherein the analysis is based on current data, historic data of a business client, and success of other business clients with similar business attributes;
a campaign manager module for generating marketing campaigns based on analysis results from the analytics manager module; and
an advertising module for facilitating at least one from a set of: online advertising, email advertising, direct mail advertising, and keyword advertising as part of the generated marketing campaigns.

17. The computer-readable storage medium of claim 16, wherein the advertising module is arranged to consume images and text that incorporate the business client's brand information created on the public website for consistent messaging to customers of the business client.

18. The computer-readable storage medium of claim 16, wherein the analytics manager module is further arranged to perform Key Performance Indicator (KPI) analysis and provide KPI reports to the campaign manager, and wherein the campaign manager module is further arranged to generate the marketing campaign in a fully automatic manner based on the analysis results.

19. The computer-readable storage medium of claim 16, wherein the website manager module is further arranged to provide a secure private website to the business client and their designees as a platform for building and executing applications that exchange information with other applications associated with the public website of the business client in order to enhance customer experience at the public website of the business client, and wherein the designees include any independent software vendor for providing complementary applications that interact with the hosted service through standardized interfaces.

20. The computer-readable storage medium of claim 16, wherein the instructions further comprise:
providing a user interface to the plurality of business clients for customizing a structure of the hosted service by one of: adding new modules, removing existing modules, and setting configurations of existing modules.
